(19) United States
(12) Patent Application Publication
(10) Pub. No.: US 2022/0297385 A1
(43) Pub. Date: Sep. 22, 2022

(54) IMPOSING QUALITY REQUIREMENTS ON 3D MODELS WITH SUPPORT STRUCTURES

(71) Applicant: DENTSPLY SIRONA Inc., York, PA (US)

(72) Inventors: Simon TANAKA, Zurich (CH); Christian STAHL, Darmstadt (DE); Daniel WEISS, Heddesheim (DE)

(73) Assignee: DENTSPLY SIRONA Inc., York, PA (US)

(21) Appl. No.: 17/634,827

(22) PCT Filed: Jul. 29, 2020
(86) PCT No.: PCT/EP2020/071377

§ 371 Date: Feb. 11, 2022

(30) Foreign Application Priority Data
Aug. 19, 2019 (EP) 19192326.7

(51) Int. Cl. B29C 64/40; B29C 64/386; B33Y 50/00; G05B 19/4099

(52) U.S. Cl. CPC B29C 64/40; B29C 64/386; B33Y 50/00; G05B 19/4099; G05B 2219/49023

(57) ABSTRACT

A method of imposing quality requirements on a 3D model including support structures to be built by an additive manufacturing apparatus including: defining the surface geometry and the orientation of the 3D model with respect to the platform, the surface geometry includes surface segments. The method further includes attributing a degree of quality (L;H) to the surface segments respectively against post-processing for the subsequent removal of the support structures calculating, based on the defined orientation, the surface geometry and the degree of quality L;H) attributed; and adding the support structure to the 3D model based on the calculated positions and the degree of quality (L;H) attributed.

### TECHNICAL FIELD OF THE INVENTION

The present invention relates to an additive manufacturing method and apparatus. The present invention more particularly relates to a method of additively manufacturing a 3D model including support structures.

### BACKGROUND ART OF THE INVENTION

In additive manufacturing, a 3D object is printed layer-by-layer through light-based curing of a liquid printing medium i.e., a liquid photocurable resin, which is selectively cured under the influence of UV radiation. In a commonly known variation of additive manufacturing, the 3D objects are preferably pulled by means of a platform, upside-down out of the liquid photocurable material filled in a vat. Other variations of additive manufacturing are also known to those skilled in the art.

During the 3D printing, enough support structures must be attached to the 3D object. The locations on the surface of the 3D object where the support structures must be attached depend on the geometry of the 3D object to be 3D printed and the orientation of the 3D object with respect to the platform.

It is generally known in the art which points of a given geometry require support structures for a given orientation of the 3D object. For instance, US 2015/0151492 A1 discloses a method of generating support structures for a 3D object to be additively manufactured.

After the 3D printing, the cleaning, the thermal and/or photochemical curing of the 3D object, the support structures must be mechanically removed. The removal process is time-consuming and potentially leads to a change in the geometry of the 3D object e.g. when finishing with a rotary tool. For dental components such as dental restorations, drilling templates, dental models, and the like with high quality requirements on shape accuracy, the consequences of mechanical post-processing can become critical.

### DISCLOSURE OF THE INVENTION

An objective of the present invention is to overcome the disadvantages of the prior art and provide a method of imposing quality requirements on a 3D model including support structures to be built by an additive manufacturing apparatus.

This objective has been achieved through the method as defined in claim 1. The dependent claims relate to further developments.

The present invention provides a method of imposing quality requirements on a 3D model including support structures to be built by an additive manufacturing apparatus which comprises a platform for holding the 3D object corresponding to the 3D model. The method comprises: a step of defining the surface geometry and the orientation of the 3D model with respect to the platform, wherein the surface geometry includes surface segments; a step of attributing a degree of quality to the surface segments respectively against post-processing for the subsequent removal of the support structures; a step of calculating, based on the defined orientation, the surface geometry and the degree of quality attributed, the positions on the surface segments where the support structure may be added; and a step of adding the support structure to the 3D model based on the calculated positions and the degree of quality attributed.

A major advantageous effect of the present invention is that, the support structures can be avoided or reduced as much as possible at such locations which, compared to other locations of the 3D object to be 3D printed, have an increased need for protection against mechanical post-processing. Thereby surface artefacts, surface damages, deformations due to mechanical post-processing can be avoided or reduced in sensitive surface segments of the 3D model, and the need for investing manual extra work for a precise removal of the support structures can be obviated or reduced as much as possible. Thereby also the time required for manual post-processing of the 3D printed object can be reduced, and costs can be saved.

According to the present invention, the method steps are performed entirely or at least partly through a computer algorithm. The computer algorithm preferably comprises a neural network capable of recognizing features of the 3D model to be built by the additive manufacturing apparatus. The steps are further performed preferably based on the recognized features. The neural network can be trained with real or simulated 3D models to recognize the surface segments which are sensitive against post-processing. Despite the use of a computer algorithm, in the attributing step a user is optionally allowed to manually mark, on a display of the 3D model, one or more surface segments respectively with a desired degree of quality, or also to define the number of degrees of qualities that can be selectively attributed.

According to the present invention, the degree of quality comprises at least a low degree of quality and a high degree of quality. The low degree of quality implies that the respective surface segment is not worth protecting in post-processing. The high degree of quality implies that the respective surface segment is worth protecting in post-processing. One or more intermediate degrees of quality may also be additionally employed to improve the results.

According to the present invention, specifically in the calculating step, to each surface segment a quantity which indicates a measure of the need of that surface segment to be supported through a support structure is optionally assigned. A larger value of the quantity indicates a stronger need for support. The quantity is preferably a scalar quantity which is a function of the inclination of the surface segment with respect to the building direction. The scalar quantity is preferably equal to the inner product of the normal vector of the surface segment and the unit vector opposite to the building direction. Preferably no support structure is added to the 3D model at a position that falls into a surface segment whose normal vector has a positive component in the building direction. That means such surface segments which point away from the building platform are not suitable for the attachment of a supporting structure. According to the present invention, in the calculating step optionally, first, the positions of all local minima of the 3D model are found with respect to the building direction, and the support structures corresponding to the positions at the local minima are added to the 3D model regardless of the attributed degree of quality. Thereby the risk of misprints can be prevented or reduced as much as possible. According to the present invention, specifically in the calculating step the assignment of the quantity to the surface segment is optionally updated such that the quantity is equal to a first constant for a surface segment at whose position a support structure has been added, and such that the quantities of the neighboring surface segments are reduced through a factor which is a function depending on the three-dimensional distance vector from the surface segment to which the support structure has been added to the neighboring surface segment, wherein the function is unity if the three-dimensional distance vector has no positive component in building direction. The function preferably asymptotically approaches unity with increasing magnitude of the three-dimensional distance vector. Thereafter, the updated quantities of the surface segments are grouped in descending order into groups corresponding to the attributed degree of quality in ascending order. Finally, commencing from the group of the lowest degree of quality to the group of the highest degree of quality, a support structure is added at the surface segment with the largest updated quantity. The steps are repeated for each group until the updated highest quantities drop below predetermined levels respectively associated with the groups.

According to the present invention, the support structures for which the calculated positions fall into in the surface segments which have been attributed a high degree of quality, are optionally not added to the 3D model. Thereby the surface segments which are sensitive against post processing can be protected.

According to the present invention, the support structures for which the calculated positions fall into in the surface segments which have been attributed a high degree of quality are alternatively optionally displaced to nearby surface segments which have been attributed a low degree of quality. Thereby the surface segments which are sensitive against post processing can be protected.

According to the present invention, the surface geometry of the 3D model is preferably represented through triangulation. Such triangulation is convenient for the calculations. Alternatively, other type of meshes with different geometries may be used.

The present invention also provides a computer algorithm having computer-readable codes for causing a CAD module to carry out the method steps. The present invention also provides a computer readable storage which stores the computer algorithm.

BRIEF DESCRIPTION OF THE D WINGS

In the subsequent description, further aspects and advantageous effects of the present invention will be described in more detail by using exemplary embodiments and by referring to the drawings, wherein

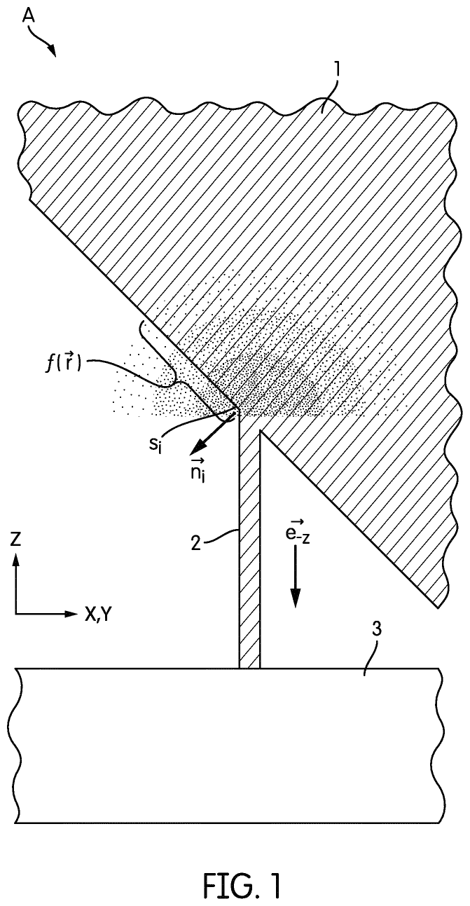

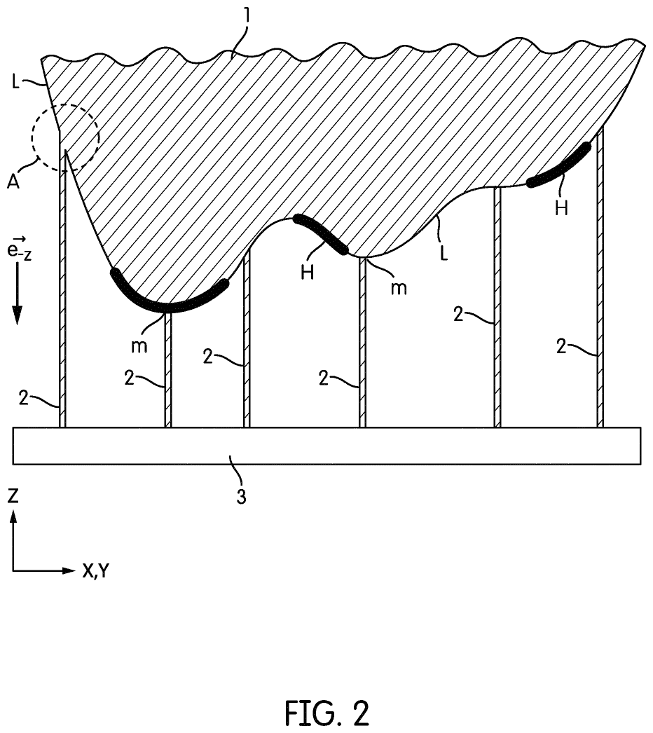

FIG. 1—is an enlarged view of the detail A in FIG. 2, which shows a support structure added to a surface segment on the 3D model;

FIG. 2—shows the support structures added to the 3D model.

The reference numbers shown in the drawings denote the elements as listed below and will be referred to in the subsequent description of the exemplary embodiments:
1. 3D model/3D Object
2. Support structure
3. Platform

L; H: Degree of quality

L: Low degree of quality

H: High degree of quality

m: Local minima

i: Integer

sᵢ: Scalar Quantity

\vec{n}ₗ: Normal vector of the i ^{th} surface segment

\vec{e_{-z}}:Vertical unit vector directed towards the platform

z: Vertical direction

c₁, c₂, c₃ Constants

f(\vec{r}): Function (factor)

\vec{r}: Three-dimensional distance vector

r: Magnitude of \vec{r}

FIG. 2 shows a part of a 3D object (1) according to an embodiment of the present invention. The 3D object (1) is partly built with an additive manufacturing apparatus. The building direction is the z direction. The additive manufacturing apparatus has a platform (3) for holding the 3D object (1). The 3D object (1) includes support structures (2) attached to the platform (3). The 3D object (1) corresponds to a 3D model (1) to which quality requirements have been imposed through the method of the present invention. The method steps are performed through a computer algorithm. The computer algorithm preferably comprises a neural network capable of recognizing features of the 3D model. The method steps are further performed based on these recognized features. The method steps will be described in the following. In a defining step, the surface geometry and the orientation of the 3D model (1) is defined with respect to the platform (3). The surface geometry includes a plurality of surface segments. The surface geometry of the 3D model (1) is represented through triangulation such that the surface segments are triangles (not shown). Other representations may be alternatively used. In an attributing step, a degree of quality (L;H) is attributed to the surface segments respectively indicating the sensitivity and the need of protection against post-processing during any subsequent removal of the support structures (2). The degree of quality (L;H) comprises preferably at least a low degree of quality (L) and a high degree of quality (H). Further degrees of quality may be optionally added. In the attributing step, the user is allowed to mark, on a display of the 3D model (1), one or more surface segments respectively with a desired degree of quality (L;H). Alternatively, the attributing step can be performed entirely by the computer algorithm, without intervention of the user, based on the recognized features. As shown in the exemplary embodiment in FIG. 2, the thick lines on the surface segments of the 3D model (1) indicate a high degree of quality attributed. Other surface segments of the 3D model (1) indicate a low degree of quality attributed. In the calculating step, based on the defined orientation, the surface geometry, and the degree of quality (L;H) attributed, the positions on the surface segments where the support structure (2) may be added are calculated. The calculation step will be explained in more detail with the help of FIG. 1 which is an enlarged view of the detail A in FIG. 2. In the calculating step, as shown in FIG. 1, the i^{th} surface segment is assigned a quantity sᵢ which indicates a measure of the need of the i^{th} surface segment to be supported through a support structure (2). i denotes an integer. The larger value of sᵢ indicates a stronger need for support. The quantity sᵢ is a scalar quantity which is a function of the inclination of the i^{th}surface segment with respect to the building direction. To be specific, sᵢ=\vec{nₗ}⋅\vec{e_{z}}, where “⋅” denotes the inner product, \vec{nₗ} denotes the normal vector of the i^{th} surface segment, and \vec{e_{-z}} denotes the vertical unit vector directed towards the platform (3). No support structure (2) is added to the 3D model (1) at a position that falls into a surface segment with sᵢ<0, i.e., whose normal vector has a positive component in the building direction. In the calculation step, as shown in FIG. 2, first, the positions of all local minima (m) of the 3D model (1) are found. In an adding step, the support structure (2) are added to the 3D model (1) based on the calculated positions and the degree of quality (L;H) attributed. In the adding step, first, the support structures (2) corresponding to the positions at the local minima (m) are added to the 3D model (1) regardless of the value of the attributed degree of quality (L; H). Next, in the calculating step, the assignment of the quantity sᵢ to the i^{th} surface segment is updated (reassigned) such that sᵢ=c₁ for a surface segment at whose position a support structure (2) has been added, and such that the sᵢ quantities of the neighboring surface segments are reduced through a factor, namely a function f (\vec{r}) wherein \vec{r} is the three-dimensional distance vector from the surface segment to which the support structure (2) has been added to the neighboring surface segment. The function f (\vec{r}) is asymptotically approaching unity with increasing magnitude of \vec{r}. The dotted area in FIG. 1 indicates the range of the factor f (\vec{r}) in the building direction. For example, f (\vec{r}) is preferably defined through the function 1−Exp [−r²/c₂²]. Here r is the magnitude of \vec{r}. The constant c₂ is a positive constant for the normalization. And f (\vec{r}) is unity if \vec{r} has no positive component in building direction. The curly bracket indicates at least part of the range of application of the factor f (\vec{r}) in the building direction. The constant c₁ is preferably equal to zero. Next, in the calculating step, the updated sᵢquantities of the surface segments are grouped in descending order into groups corresponding to the attributed degree of quality. And the groups are further arranged in an ascending order. Next, commencing from the group of the lowest degree of quality (L) to the group of the highest degree of quality (H), a support structure (2) is added at the surface segment with the largest updated sᵢ quantity. The procedure is cyclically repeated until the updated highest sᵢ quantities drop below predetermined levels c₃ associated with the groups respectively. c₃ are constants and define how strongly the 3D model (1) is to be supported. A stronger suppression of support structures (2) on surface segments with higher degree of quality attributed can be achieved by selecting the constant c₃ higher for the higher degree of quality. Furthermore, the total number of added support structures (2) can be influenced by the parameter c₂.

In an alternative embodiment. the support structures (2) for which the calculated positions fall into surface segments which have been attributed a high degree of quality (H) are not added to the 3D model (1).

In another alternative embodiment, the support structures (2) for which the calculated positions fall into surface segments which have been attributed a high degree of quality (H) are displaced to nearby surface segments which have been attributed a low degree quality (L).

1. A method of imposing quality requirements on a 3D model including support structures to be built by an additive manufacturing apparatus comprising: a platform for holding the 3D object corresponding to the 3D model, the method comprising:
a step of defining the surface geometry and the orientation of the 3D model with respect to the platform, wherein the surface geometry includes surface segments; further comprising:
a step of attributing a degree of quality (L;H) to the surface segments respectively against post-processing for the subsequent removal of the support structures;
a step of calculating, based on the defined orientation, the surface geometry and the degree of quality (L;H) attributed, the positions on the surface segments where the support structure is added; and
a step of adding the support structure to the 3D model based on the calculated positions and the degree of quality (L;H) attributed.

2. The method according to claim 1, wherein the steps are performed through a computer algorithm that comprises a neural network capable of recognizing features of the 3D model, wherein the steps are further performed based on the recognized features.

3. The method according to claim 1, wherein in the attributing step a user manually marks, on a display of the 3D model, one or more surface segments respectively with a desired degree of quality (L,H).

4. The method according to claims 1, wherein the degree of quality (L;H) comprises at least a low degree of quality (L) and a high degree of quality (H).

5. The method according to claim 4, wherein the support structures for which the calculated positions fall into surface segments which have been attributed a high degree of quality (H) are not added to the 3D model.

6. (Currently Tended) The method according to claim 4, characterized in that in the adding step the support structures for which the calculated positions fall into surface segments which have been attributed a high degree of quality (H) are displaced to nearby surface segments which have been attributed a low degree of quality (L).

7. The method according to claim 1, wherein in the calculation step, first, the positions of all local minima (m) of the 3D model are found: and
in the adding step the support structures corresponding to the positions at the local minima (m) are added to the 3D model regardless of the attributed degree of quality (L;H).

8. The method according to claim 1, wherein in the calculating step, the i^{th} surface segment is assigned a quantity sᵢ which indicates a measure of the need of the i^{th} surface segment to be supported through a support structure, wherein a larger value of sᵢ indicates a stronger need for support.

9. The method according to claim 8, wherein the quantity sᵢ is a scalar quantity which is a function of the inclination of the i^{th} surface segment with respect to the building direction.

10. The method according to claim 9, wherein no support structure is added to the 3D model at a position that falls into a surface segment whose normal vector has a positive component in the building direction.

11. The method according to claim 10, wherein in the calculating step,
the assignment of the quantity sᵢ to the i^{th} surface segment is updated such that sᵢ=c₁ for a surface segment at whose position a support structure has been added, and that the sᵢ quantities of the neighboring surface segments are reduced through a factor f (\vec{r}) wherein \vec{r} is the three-dimensional distance vector from the surface segment to which the support structure (2) has been added to the neighboring surface segment, wherein f (\vec{r}) is unity if \vec{r} has no component in building direction;
the updated s, quantities of the surface segments are grouped in descending order into respective groups corresponding to the attributed degree of quality in ascending order:
commencing from the group of the lowest degree of quality (L) to the group of the highest degree of quality (H), a support structure is added at the surface segment with the largest updated sᵢ quantity; and
the procedure is repeated until the updated highest sᵢ quantities in each group drop below predetermined levels c₃ associated with the groups respectively, wherein each c₃ is a constant.

12. The method according to claim 11, wherein the function f (\vec{r}) asymptotically approaches unity with increasing magnitude of \vec{r}.

13. The method according to claim 12, wherein the function f (\vec{r}) is defined through
$$1 - {e}^{- \frac{{r}^{2}}{{c}_{2}^{2}}}$$
where c₂ is a positive constant.

14. The method according to claim 12, wherein c₁=0.

15. A computer program comprising computer readable codes for causing a CAD/CAM module to carry out the steps of the method according to claim 1.

16. A non-transitory, computer readable storage medium which stores the program according to claim 15.
